(19) United States
(12) Patent Application Publication
(10) Pub. No.: US 2015/0101440 A1
(43) Pub. Date: Apr. 16, 2015

(54) MULTIFUNCTIONAL CONTROL FOR A WORK VEHICLE

(71) Applicant: Deere & Company, Moline, IL (US)

(72) Inventors: Stephen E. Bonneau, Dubuque, IA (US); Lucas J. Wallace, Dubuque, IA (US); Ronald J. Huber, Dubuque, IA (US); Giovanni A. Wuisan, Epworth, IA (US); Jonathan E. Drum, Raleigh, NC (US); Donald W. Kruger, Cuba City, WI (US); Ryan N. Detweiler, Dubuque, IA (US); Harry E. Rawlins, IV, Dubuque, IA (US); Jason C. Lahey, Dubuque, IA (US)

(73) Assignee: Deere & Company, Moline, IL (US)

(21) Appl. No.: 14/052,625

(22) Filed: Oct. 11, 2013

(51) Int. Cl. G05G 1/01

(52) U.S. Cl. CPC G05G 1/01
USPC 74/484 R

(57) ABSTRACT

A multifunction control for a work vehicle provides a control lever mounted control grip forming a hand rest, pommel and control face. The hand rest is ergonomically contoured to support an under side of a vehicle operator's hand in a neutral position. The operator can position the control front to back and laterally with the hand in a relaxed state. The operator can move the control in one lateral direction by contacting the pommel with a finger and in the opposite direction by contacting the control face, or guard thereon, with a thumb. One or more control switches can be mounted on the control face in reach of the thumb and also at a frontal location in reach of a finger. The switches can be activated without straining or repositioning the hand on the hand rest.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to operator controls for work vehicles, and in particular to hand controls with multi-functional capabilities for controlling various components of the work vehicle from an operator station within the vehicle cabin.

### BACKGROUND OF THE DISCLOSURE

Work vehicles, such as those used in the agriculture, construction and forestry industries, typically are large, heavy-duty machines that have a complex control system for operating the various vehicle sub-systems and implements from an operator station within the vehicle cabin. Often, a single operator is required to operate the drive and steering systems of the work vehicle, while simultaneously controlling the position, articulation or operation of one or more implement attachments.

An example work vehicle of this type is a backhoe loader. A typical backhoe loader has an internal combustion engine coupled to a drive train having suitable steering, gearing and/or supplemental drive mechanisms sufficient to rotate ground-contacting wheels to drive the vehicle either in the forward or rearward direction. A chassis supports the operator cabin and work implements, which typically operate under hydraulic power. Example work implements include a front loader bucket mounted to articulating boom arms and used to carry above ground loads, and a rear backhoe, which has a smaller bucket mounted to the end of articulating boom arms and used for excavation. Inside the cabin are any number of control devices, for example, a throttle control, brake lever, and steering wheel that allow the operator to control the work vehicle heading and speed, as well as other controls for changing transmission and drive settings. The cabin operator station also has one or more controls for operating the work implements. For example, the work vehicle can have one or more stick-mounted hand controls mounted to the seat, floor or console of the operator station inside the cabin alongside or in front of the operator seat. The control(s) can be manipulated by the operator to actuate hydraulic cylinders to, for example, raise, lower and tip the front bucket, and articulate the backhoe boom and bucket as well as swing the backhoe laterally and extend and retract it in the fore and aft directions. Typically, the operator controls the height of the loader bucket by pivoting the control lever in the fore and aft directions to thereby raise and lower, respectively, the boom arms supporting the bucket. Bucket articulation is typically achieved through other pivoting of the control lever, such as in the lateral or sidewise direction of the vehicle.

One significant challenge in the design of work vehicles of this type is to provide all the controls necessary to operate the various systems of the vehicle and the work implements in a manner that does not cause the operator to suffer undue strain and fatigue during use. For example, some existing hand controls used in work vehicle applications have a pistol-style grip configuration in which the operator's hand takes a power or crush style grip in which the control is held firmly against the palm by the fingers. This grip style allows the operator's hand to be in a generally vertically neutral position between the supine and pronated positions, and calls upon the larger muscles of the forearm and upper arm to effect fore and aft and lateral movements of the control. However, because the thumb is positioned vertically above and at the opposite side of the control from the other digits of the hand, the control does not support the entire hand, but rather requires the fingers to be in a state of flexion to stay wrapped around the control. Also, with one's hand in this orientation, lateral movement of the control is generally effected by a more limited muscle group, such as the smaller muscles of the forearm and wrist, rather than also including the larger muscles of the upper arm and shoulder. These factors can lead to operator fatigue during operation of the control. Further, pistol grip configurations can have limited space available to mount the number of switches required to control the work implements, or the placement of the switches, for example on the upper end of the control, may cause the switches to be difficult to reach without straining or releasing the control.

Palm-on-top style control grips alleviate some of the aforementioned issues. As the name implies, palm-on-top grips generally support the entire hand from the underside with the palm resting on the top of the control. Further, when the height of the control is coordinated to the height of the armrest on the operator's seat, the wrist can be in a generally neutral orientation with respect to the forearm. However, typical grips, which are manipulated with the hand in a pronated, or palm-down, position may require the operator to more firmly grip the control during operation, and the operator may need to curl the finger tips to press against the under side of the control using the small muscles of the hand. This not only leads to fatigue, it also prevents the fingers from manipulating control switches as may be needed to activate the desired functions of the work implements. Moreover, often the upper surface of such palm-on-top grips is too small and uncomfortable. And, since the upper surface of palm-on-top grips is used to support the hand, there is often no room for switches, or they are located in less accessible locations on the control, which may require the hand to be lifted or repositioned and may preclude simultaneous activation of multiple control switches.

Yet another significant issue for work vehicles of this type is to provide the operator with the numerous controls in a manner that are readily accessible without interfering with the operator's movement within or to the cabin (e.g., ingress and egress) or being inadvertently actuated during operation of the vehicle, for example when the vehicle is being driven over uneven terrain. Another challenge is grouping controls in a manner that is intuitive to the operator (e.g., in terms of spatial layout and functional grouping of the switches) and allows the operator to access multiple controls simultaneously (e.g., to allow the loader bucket to be raised or lowered simultaneously with articulation of the bucket).

An improved hand control interface for work vehicles is thus needed.

### SUMMARY OF THE DISCLOSURE

This disclosure addresses the aforementioned issues common in existing control grips by providing a palm-on-top style grip with improved configuration that better positions the operator's hand from both an ergonomic standpoint and an operational control standpoint.

One aspect of the disclosure provides a multifunction palm-on-top control grip for a work vehicle, which includes a hand rest, a pommel, and a control face. The hand rest is ergonomically contoured to support an under side of a human hand. The pommel defines one or more raised surfaces between at least a portion of the hand rest and the control face that are configured to be acted against on one side by a finger, such as the index finger. One or more control switches can be mounted in the control face and arranged to be manipulated by the thumb without repositioning the hand. The one or more control switches are operatively coupled to components of the work vehicle.

Another aspect of the disclosure provides a multifunction palm-on-top control grip for a work vehicle. The control grip includes a hand rest at a first side of the control grip, a control face at a second side of the control grip, and a pommel defining a raised projection between the hand rest and control face. The hand rest has a convex surface extending from the first side of the control grip to a concave transition region, which smoothly transitions between the hand rest and the pommel. The pommel has a convex surface that smoothly transitions from the transition region to the control face. The transition region can have a radius of curvature less than that of adjacent portions of the convex surfaces of the hand rest and the pommel, and the control face defines a planar surface defining the second side of the control grip.

Another aspect of the disclosure provides a multi-function control mounted within the operator station of a work vehicle. The control includes a control lever, which can be mounted to the floor, seat or any raised platform or console, such as by a joystick base, and a control grip defining a hand rest, a control face and a pommel. The hand rest defines a contoured convex surface extending from a first side of the control grip. The pommel defines a projection between at least a portion of the hand rest and the control face that is configured to be acted against by a hand of an operator. The control face defines a broad surface, such as a flat, planar wall that mounts one or more control switches arranged to be manipulated by a thumb of the operator and which are operatively coupled to components of the work vehicle. The control grip is mounted to the control lever such that the pommel projects in an upward direction away from the floor and the control face extends in a plane approximately normal to the floor.

Additional aspects and advantages of the disclosure can be found in the description and drawings referenced below.

### BRIEF DESCRIPTION OF THE DRAWINGS

FIG. 1 is a perspective view of an example work vehicle in the form of a backhoe loader in which a control as described herein can be used;

FIG. 2 is a simplified perspective view of an operator station inside a cab of the backhoe loader of FIG. 1 showing an example control grip mounted on a control lever;

FIG. 3 is a partial perspective view of the control grip and control lever;

FIG. 4 is a side view thereof showing an example positioning of an operator's hand superimposed on the control grip;

FIG. 5 is a front exploded assembly view thereof;

FIG. 6 is a rear exploded assembly view thereof;

FIG. 7 is a front view thereof showing another example positioning of an operator's hand superimposed on the control grip;

FIG. 8 is a rear view thereof;

FIG. 9 is a partial front view of an example mounting of the control grip and control lever relative to an operator seat armrest showing an operator's hand and arm superimposed therein, the control lever being shown in a neutral position;

FIG. 10 is a side view thereof;

FIG. 11 is a perspective view of the control having an alternate switch grouping; and

FIG. 12 is a perspective view showing the control without switches.

### DETAILED DESCRIPTION

As shown in the accompanying figures of the drawings described above, the following describes one or more example constructions of a control lever grip for a work vehicle. Various modifications to the example construction(s) may be contemplated by one skilled in the art.

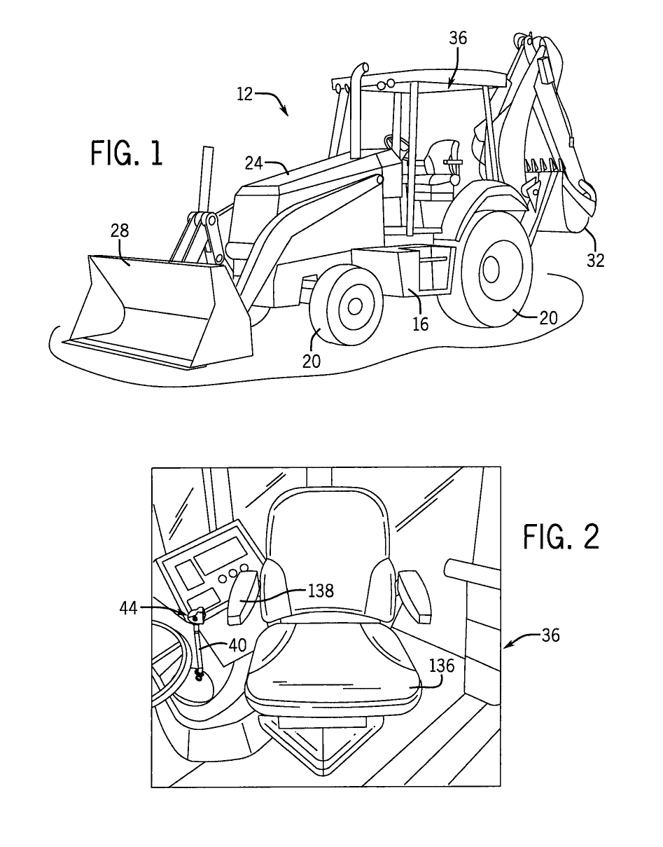

FIG. 1 shows an example work vehicle in the form of a backhoe loader 12 that includes a frame 16 supported for movement over the ground by four wheels 20. It should be noted that the present disclosure can be utilized in any type of vehicle, including any of the numerous off-road vehicles used in the construction, forestry and agricultural industries (e.g., tractors, loaders, skidders, harvesters, etc.). Other on-road or off-road vehicles may also benefit from the control grip of this disclosure, including without limitation, various utility and recreational off-road vehicles.

The example backhoe loader 12 illustrated in the drawings includes a frame 16 that mounts an engine 24, a first implement in the form of a bucket 28, a second implement in the form of a backhoe 32, and an operator cab 36. The engine 24 is arranged to provide power to the wheels 20, the bucket 28, and the backhoe 32. The cab 36 includes a plurality of user interfaces that control the backhoe loader 12. The backhoe loader 12 includes a control lever 40 that can be used to manipulate the bucket 28, auxiliary loader attachments or other aspects of the backhoe loader 12.

FIG. 2 shows the cab 36 of the backhoe loader 12 including the control lever 40 with a palm-on-top style control grip 44. It should be noted that the control grip 44 can be mounted within the operator cab 36 at any suitable location and mounted to any suitable component, including without limitation, the cab floor, an elevated console or an operator seat. Also, rather than a control lever 40, the control grip 44 can be mounted to a joystick base, which provides the positioning interface for the control grip 44 to the loader 12.

The control grip 44 is used to control a primary loader function (such as the bucket 28) of the backhoe loader 12. A number of switches, rollers, or rockers can populate the control grip 44 and be used to control various transmissions, hydraulic and electrical systems of the backhoe loader 12. As discussed in more detail below, the shape of the control grip 44 allows for an ergonomically correct neutral wrist position through the entire range of motion of the control lever 40, and the top of the control grip 44 is curved to fit the natural contours of a relaxed hand. In other words, the configuration of the grip 44 allows the operator's hand and arm to take and maintain a less physically demanding posture to reduce the risk of fatigue during operation.

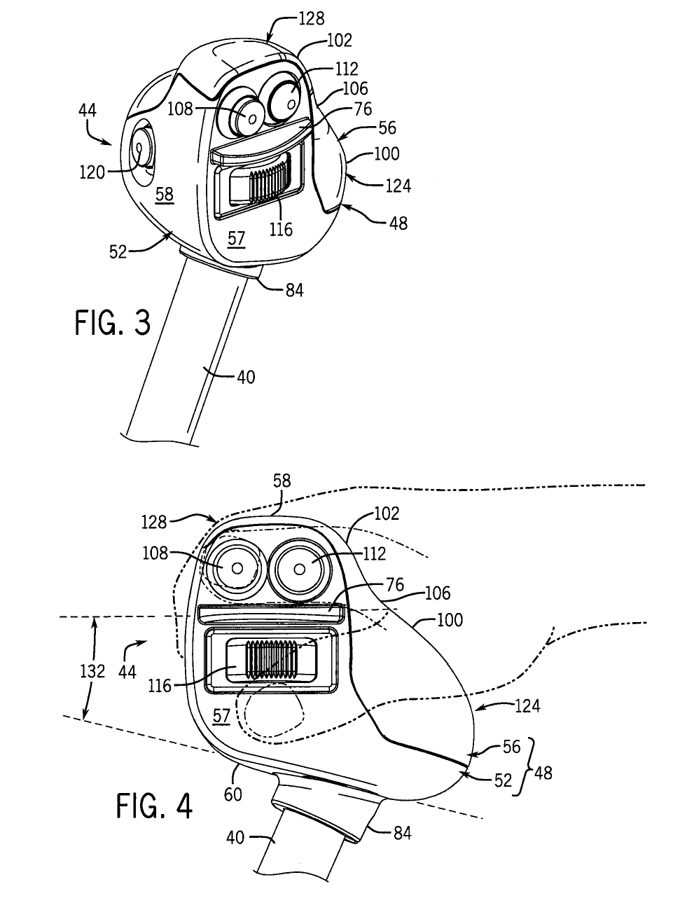

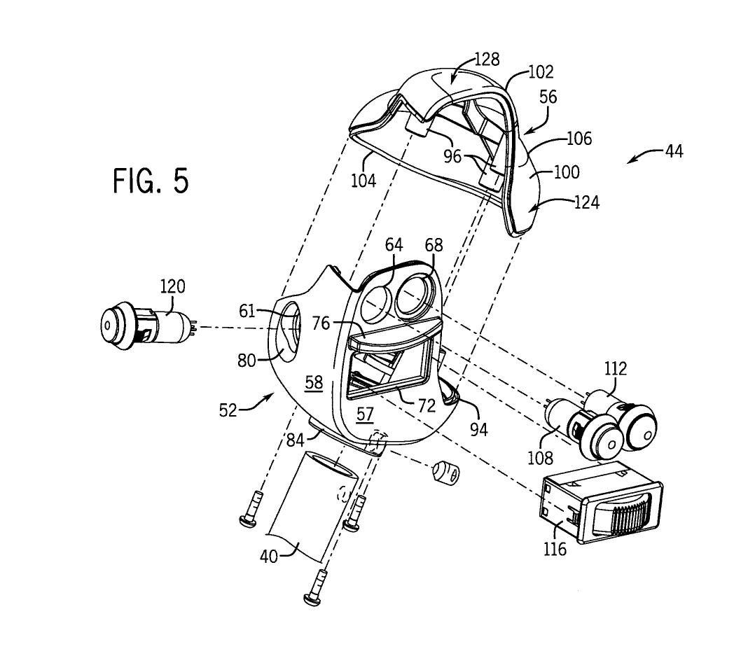

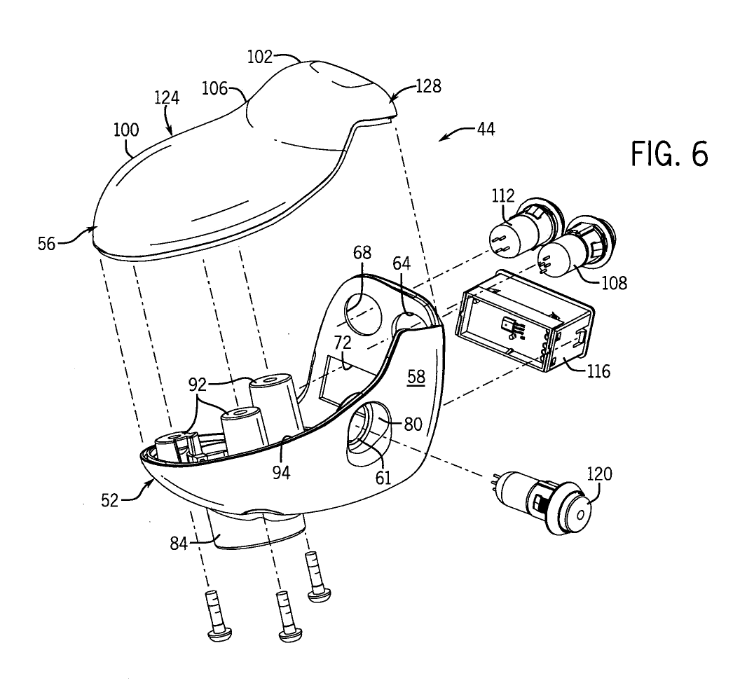

Turning to FIGS. 3-6, the control grip 44 has a housing 48 that includes a first shell 52 and a second shell 56 coupled to the first shell 52. The first shell 52 defines a thumb control face 57 arranged to be easily reached by the operator's thumb and a peripheral surface 58 that extends around the sides of the thumb control face 57. The thumb control face 57 can be substantially flat or planar and generally extends from an upper bound 59 of the first shell 52 to a lower bound 60 of the first shell 52 (see FIG. 4). It should be noted that the control grip 44 is illustrated in a right hand configuration in which the operator's right hand and arm manipulate the control grip 44. However, the control grip 44 could be provided in a left hand configuration for manipulation with the operator's left hand and arm by forming the housing, and it's first and second shells, in mirror image. Moreover, it should be noted that the housing could be formed as a monolithic shell, or in more parts than the two shells described herein.

The first shell 52 further defines a first aperture in the form of a momentary four-wheel drive (MFWD) aperture 61, a second aperture in the form of a clutch disconnect aperture 64, a third aperture in the form of a kickdown aperture 68, and a fourth aperture in the form of a rocker aperture 72. A thumb guard 76 projects from the thumb control face 57 and defines a curved profile.

The clutch disconnect aperture 64, the kickdown aperture 68, and the rocker aperture 72 are formed in the thumb control face 57. The clutch disconnect aperture 64 and the kickdown aperture 68 are arranged near the upper bound 59 with the clutch disconnect aperture 64 arranged forward of the kickdown aperture 68, or to the left as viewed from the perspective shown in FIG. 4. The thumb guard 76 is arranged below the clutch disconnect aperture 64 and the kickdown aperture 68 and above the rocker aperture 72. As shown in FIG. 4, the clutch disconnect aperture 64, the kickdown aperture 68, the thumb guard 76, and the rocker aperture 72 are grouped together and aligned generally parallel to the horizon.

The MFWD aperture 61 is arranged on the peripheral surface 58 and positioned within easy reach of the operator's index finger or middle finger. The MFWD aperture 61 is positioned in a recess 80 and arranged at approximately the same vertical height as the rocker aperture 72 with respect to the upper bound 59 and the lower bound 60.

A mounting feature in the form of a female collar or sleeve 84 is arranged at a bottom surface of the first shell 52 for attaching the control grip 44 to the control lever 40. The sleeve 84 includes a cutout 88 (see FIG. 8) sized to receive a fastener for securing the sleeve 84 and thereby the control grip 44 to the control lever 40. Three recessed fastener apertures 92 are arranged on the bottom surface of the first shell 52 and a groove 94 runs around the top periphery of the first shell 52.

The second shell 56 defines three bosses 96 positioned to align with the three recessed fastener apertures 92 on the first shell 52, a contoured upper surface 100, and a tab 104 that extends around a periphery of the second shell 56 and is arranged to engage the groove 94 of the first shell 52. The second shell 56 is coupled to the first shell 52 by inserting the tab 104 into the groove 94 and threading fasteners through the recessed fastener apertures 92 and into the bosses 96. In the illustrated construction, the housing 48 is constructed of textured hard plastic. In other constructions, a leather cover, soft plastic, gel padding, or other materials may be used, as desired.

A clutch disconnect button 108 is engaged within the clutch disconnect aperture 64 and arranged and operatively coupled to selectively engage and disengage a clutch in the drive train of the backhoe loader 12. The illustrated clutch disconnect button 108 snaps into place, though other engagement styles are contemplated. In one construction, the clutch disconnect button 108 is a spring return momentary switch.

A kickdown button 112 is engaged within the kickdown aperture 68 and arranged and operatively coupled to lower the gear ratio of the backhoe loader's 12 gear train by one gear per depression of the kickdown button 112. The illustrated kickdown button 112 snaps into place, though other engagement styles are contemplated. In one construction, the kickdown button 112 is a spring return momentary switch and each depression of the kickdown button 112 lowers one gear. For example, if the vehicle is operating in a third gear, depression of the kickdown button 112 would lower the drive train to a second gear. The inclusion of a kickdown button 112 provides a quick down shift capability.

An auxiliary rocker switch 116 is engaged within the rocker aperture 72 and arranged and operatively coupled to selectively provide hydraulic pressure to an auxiliary implement, such as is commonly referred to in the industry as a third function loader hydraulic implement that can be carried by the loader booms and/or bucket to provide additional work functionality. For example, the rocker switch 116 can control attachments or implements such as an auger, a sweeper, a clamping bucket, various grapples or other implements as desired. The illustrated rocker switch 116 snaps into place, though other engagement styles are contemplated. In one construction, the rocker switch 116 is a proportional actuator with a center spring return. In use, actuation farther from center provides proportionally more hydraulic pressure differential to the implement.

A MFWD button 120 is engaged within the MFWD aperture 61 and arranged and operatively coupled to selectively actuate the drive train between a four-wheel-drive mode and a non-four-wheel-drive mode. The illustrated MFWD button 120 snaps into place, though other engagement styles are contemplated. In one construction, the MFWD button 120 is a spring return momentary switch.

The aforementioned switch grouping provides one example suitable for use with the backhoe loader 12. However, it should be understood that the control grip 44 could be formed and fitted to mount a different switch grouping, in terms of the number of switches, the layout and arrangement of the switches, and the functions and types of switches employed. Some non-limiting examples of the control grip with different switch groupings are shown and described herein, for example in FIG. 11 and in FIG. 12, which depicts a control grip without switches. It should also be noted that the switches can be configurable to allow for button mapping in which the switches can be programmed to effect selected functions that may differ for different mapping protocols.

Turning to FIGS. 3-4 and 7-8, the housing 48 provides a palm-on-top control grip 44 that is ergonomically shaped. The housing 48 is shaped to fit the relaxed form of the human hand (i.e., the operator's hand) such that the operator need only apply a minimal amount of force to grasp the control grip 44 during use. The contoured upper surface 100 includes a hand rest 124 shaped to be cupped within the relaxed palm of the operator, and a raised portion in the form of a pommel 128 arranged to fit comfortably between the index finger and the thumb of the operator.

The hand rest 124 defines the convex surface 100. The pommel 128 defines a convex surface 102. A transition region 106 exists between the hand rest 124 and the pommel 128 and defines a concave surface that smoothly transitions between the convex surface of the hand rest 124 and the convex surface of the pommel 128. The radius of curvature of the transition region 106 is less than the radius of curvature of the convex surfaces of the hand rest 124 and the pommel 128. The transition region 106 and convex surfaces 100 and 102 are shaped to support the hand in a relaxed position throughout use and operation of the control grip 44. Generally, the housing 48 is shaped to maintain the operator's wrist in a neutral and relaxed position throughout the range of motion of the control lever 40. This arrangement greatly reduces stress and fatigue compared to prior art palm-on-top and pistol style grips.

The clutch disconnect button 108, the kickdown button 112, the thumb guard 76, and the rocker switch 116 are arranged as a group that is skewed relative to the control grip 44 at an oblique angle 132. With reference to FIG. 4, the thumb guard 76 is arranged at about a fifteen-degree angle relative to the lower bound 60 of the control grip 44. The other components are arranged parallel to the thumb guard 76 such that the group as a whole is skewed. In other constructions, the group may be skewed by less than fifteen degrees or more than fifteen degrees, as desired. The skewed arrangement of the group provides a more comfortable and user friendly arrangement of the components when the control grip 44 is properly oriented with respect to the operator seat 136. Specifically, skewing the switch cluster and thumb guard 76 on the thumb control face 57 in this manner allows the switches and guard to be aligned generally parallel to the horizon when the work vehicle is on level ground, or otherwise generally parallel to the cabin floor, console or operator seat 136 and armrest 138. Mounting the control grip 44 on the control lever 40 in this orientation and at the appropriate vertical height and horizontal (front-to-back and side-to-side) position relative to the operator seat 136 and armrest 138, provides a desired ergonomic control grip 44 for the operator. It should be noted that rather than the thumb guard 76 and switches 108, 112 and 116 being arranged horizontally or essentially horizontally, the control grip 44 could be configured or mounted so that these features angle downward in the back to front direction at a prescribed angle (e.g., 5-15 degrees) to more closely follow the line of the thumb when in a natural, dropped position.

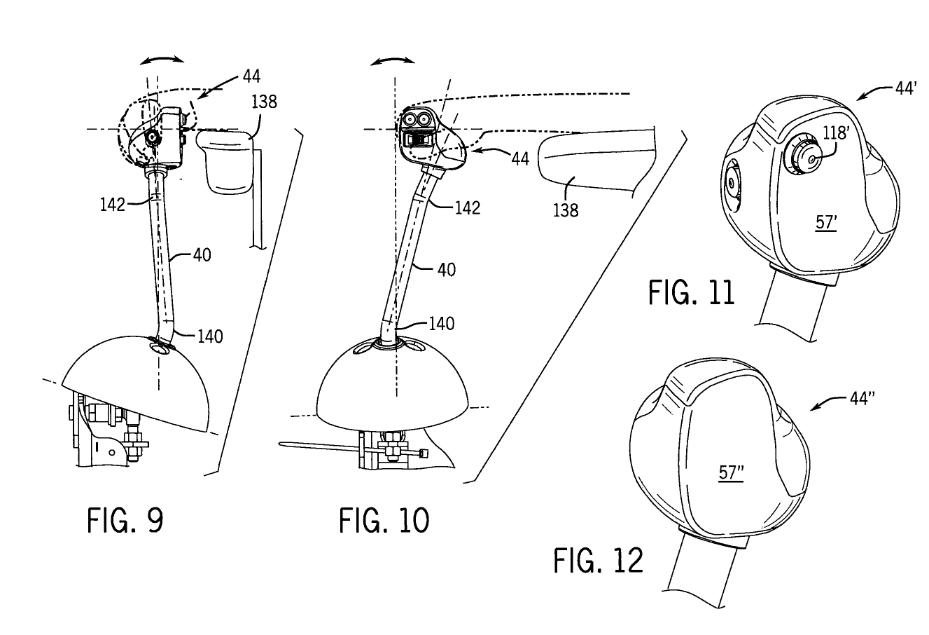

With reference to FIGS. 4, 7, 9 and 10, further details of the ergonomic orientation and positioning of the control grip 44 will now be described. The control lever 40 can be mounted to the floor or a raised platform in the operator's station of the vehicle cabin as needed to place the control grip 44 in the proper orientation and location so as to be within a comfortable reach for the operator. As shown in FIG. 10, for example, the control lever 40 is angled back from vertical in the fore and aft direction of the vehicle, at least in part, by virtue of the control lever 40 having two bends 140, 142 at lower and upper ends thereof. The control lever 40 is also angled slightly off the vertical axis in the lateral or side-to-side direction of the vehicle, as shown in FIG. 9. This mounting arrangement allows the control grip 44 to be oriented in an ergonomic manner with the pommel extending in an upward direction and the thumb control face 57 substantially vertical, or normal to the horizon (or cabin floor and operator seat 136/armrest 138), and its switch grouping and thumb guard 76 arranged generally parallel to the horizon (or cabin floor and operator seat 136/armrest 138). The control lever 40 is also mounted to position the control grip 44 slightly laterally outside (see FIG. 9) and forward (see FIG. 10) of the operator seat 136. This orientation and positioning puts the control grip 44 within reach of the operator's hand when his or her arm is resting on the armrest. The control lever 40 also mounts the control grip at a height such that the operator's relaxed hand can drop slightly from the forearm resting on the armrest to rest comfortably on the top of the control grip 44 (see FIGS. 4 and 10). The operator's hand is thus supported in a generally vertically neutral position between the supine and pronated positions.

Moreover, the configuration of the control grip 44 provides numerous surfaces for contact by the operator's relaxed hand that are oblique or orthogonal to the direction of movement of the control grip to thereby allow for less operator fatigue when manipulating the control grip 44 during operation of the vehicle. Also, the downward force of the operator's hand acting on the convex top surface 124 of the control grip 44 gives the operator large-scale position control of the control grip 44 in the fore and aft directions of the vehicle using the larger muscles of the forearm and upper arm.

For example, the operator can control the bucket height without engaging the control grip 44 using a power or crush style grip, as might be necessary in a pistol style grip configuration, which requires the operator to grasp the control grip with significant force in order to manipulate the lever 40. Rather, the disclosed control grip 44 provides a shape wherein the operator's hand and wrist are relaxed throughout the full manipulation range of the control lever 40. The operator can manipulate the control lever 40 forward, for example when lowering and raising the loader bucket boom arms, respectively, primarily using the contact force that arises between the operator's palm and the top or sides of the control grip 44 due to the force of gravity when the operator simply places his or her palm on top of the control grip. Manipulation of the control grip 44 forward can be further aided by contact engagement of the operator's hand with the pommel 128. Manipulation of the control grip 44 rearward can be provided by contact engagement of the operator's relaxed fingers and the front peripheral surface 58. Little or no additional grip force needs to be exerted by the operator, thereby allowing the operator to keep his or her hand and wrist relaxed throughout the movement with less fatigue during long periods of vehicle operation.

Furthermore, the disclosed control grip 44 allows the operator to manipulate the control lever 40 in the lateral direction with a relaxed hand by using the raised pommel 128 in cooperation with the thumb control face 57, or more specifically the thumb guard 76. For example, the operator can use the thumb to push on the thumb guard 76 to move the control lever 40 to one lateral side (such as to the right in the FIG. 8) in order, for example, to execute a bucket dump operation. The operator can use the side of a finger, such as an index, middle or ring finger, to move the control lever 40 in the opposite direction (such as to the left in FIG. 8) in order to, for example, curl the bucket upward. Both of these operations are completed while the operator's hand and wrist remain in the relaxed position and the operator has uninhibited access to the buttons 108, 112, 116, 120.

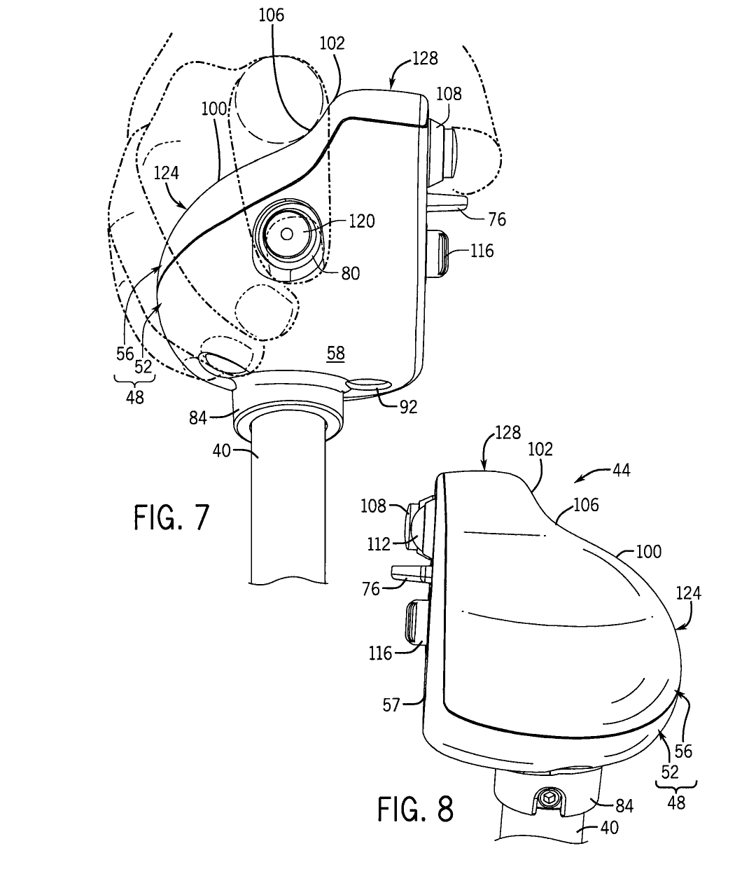

The disclosure also provides an ergonomic control grip 44 that allows the operator to manipulate various functions with fingertip control. Thus, as shown in FIGS. 4 and 7, with the thumb control face 57 along a substantially vertical plane and skewed, parallel arrangement of the switch grouping and thumb guard 76, when the control grip 44 is mounted on the control lever 40 as shown in the drawings, the operator's thumb is positioned to naturally fall over the thumb control face 57 with only slight lifting through a small angle, such as less than 30 degrees, being required to reach the switches 108, 112 and 116 or the thumb guard 76, thereby reducing thumb strain. Also, the frontal mounting location of the switch 120 allows the operator's finger to overlap the switch 120 in a relax grip condition, without requiring finger flexion to reach the switch 120, or stay on grip control. Moreover, because the aperture 61 is recessed from the front surface 58, the operator does not need to strain to avoid the switch 120 in order to prevent inadvertent activation.

Still further, the inventors do not believe that a kickdown button 112 has been integrated into a multifunction grip for a backhoe loader 12 in prior art constructions. Additionally, the position and arrangement of the MFWD button 120 allow the operator to momentarily depress the button 120 while manipulating the lever 40 to deliver bursts of four-wheel-drive operation without increasing the stress on the operator's hand and wrist. The control grip of this disclosure thus provides numerous improvements upon previous multifunction grips, such as those used in backhoe loaders, which heretofore have often been fatiguing to use.

In other constructions, one or more additional control switches and buttons may be included in the control grip 44, such as an additional button arranged next to the MFWD button 120 or in another position on the control grip 44. Furthermore, in other constructions fewer control switches and buttons may be employed. For example, as shown in FIG. 11, the control grip 44′ can have a single button, such as clutch disconnect button 108′, on the thumb control face 57′ without the other switches or the thumb guard shown in the FIG. 3 embodiment. Alternatively, as shown in FIG. 12, the control grip 44″ can be without any switches or buttons, or thumb guard, on the thumb control face 57″ or other surfaces of the control grip 44″. In the embodiments of FIGS. 11 and 12, however, the control grips 44′ and 44″ would be otherwise formed with the same or similar contouring and pommel configuration and would be oriented and positioned in a like manner as described above with respect to the FIG. 3 embodiment to provide the ergonomic benefits described.

The description of the present disclosure has been presented for purposes of illustration and description, but is not intended to be exhaustive or limiting to the disclosure. Many modifications and variations will be apparent to those of ordinary skill in the art without departing from the scope and spirit of the disclosure. Explicitly referenced embodiments herein were chosen and described in order to explain the principles of the disclosure and their practical application, and to enable others of ordinary skill in the art to understand the disclosure and recognize many alternatives, modifications, and variations on the described examples. Accordingly, various embodiments and implementations other than those explicitly described are within the scope of the following claims.

What is claimed is:

1. A multifunction palm-on-top control grip for a work vehicle, the control grip comprising:
a hand rest ergonomically contoured to support an under side of a human hand;
a control face mounting at least one control switch operatively coupled to a component of the work vehicle, the at least one control switch being arranged to be manipulated by a thumb of the hand without repositioning the hand on the hand rest; and
a pommel defining at least one raised surface between at least a portion of the hand rest and the control face configured to be acted against by a finger of the hand without repositioning the hand on the hand rest.

2. The multifunction palm-on-top control grip of claim 1, wherein the control face is planar.

3. The multifunction palm-on-top control grip of claim 1, wherein the pommel is an upper forward region of the control grip.

4. The multifunction palm-on-top control grip of claim 1, further comprising a control switch arranged on a front peripheral region of the control grip, the control switch being recessed and arranged to be manipulated with a finger of the hand without repositioning the hand on the hand rest.

5. The multifunction palm-on-top control grip of claim 4, wherein the at least one control switch is arranged to be manipulated with a thumb while the control switch at the front peripheral region is manipulated with a forefinger of the hand.

6. The multifunction palm-on-top control grip of claim 1, wherein the control grip is formed of a housing having a first shell defining the hand rest and the pommel, and a second shell defining the control face.

7. The multifunction palm-on-top control grip of claim 1, wherein the at least one control switch is a kickdown switch configured to control a geartrain component of the work vehicle.

8. The multifunction palm-on-top control grip of claim 1, wherein there are multiple control switches at the control face including a clutch control switch, a kickdown switch, and a rocker switch.

9. The multifunction palm-on-top control grip of claim 8, wherein the clutch control switch, the kickdown switch, and the rocker switch are arranged at oblique angles along the control face with respect to a lower bound of the control grip.

10. The multifunction palm-on-top control grip of claim 9, further comprising a thumb guard projecting from the control face between the rocker switch and the clutch control and kickdown switches.

11. The multifunction palm-on-top control grip of claim 1, further comprising a manual four wheel drive switch arranged on a front peripheral region of the control grip, the manual four wheel drive switch arranged to be manipulated with a forefinger;
wherein the manual four wheel drive switch is arranged such that simultaneous activation of the manual four wheel drive switch and the at least one control switch is achievable without repositioning the hand on the hand rest.

12. A multifunction palm-on-top control grip for a work vehicle, the control grip comprising:
a hand rest at a first side of the control grip;
a control face at a second side of the control grip; and
a pommel defining a raised projection between the hand rest and control face;
wherein the hand rest has a convex surface extending from the first side of the control grip to a concave transition region which smoothly transitions between the hand rest and the pommel;
wherein the pommel has a convex surface that smoothly transitions from the transition region to the control face, the transition region having a radius of curvature less than that of adjacent portions of the convex surfaces of the hand rest and the pommel; and
wherein the control face defines a planar surface defining the second side of the control grip.

13. The multifunction palm-on-top control grip of claim 12, wherein a plurality of control switches are mounted to the control face.

14. The multifunction palm-on-top control grip of claim 13, wherein the pommel defines a raised surface at a forward portion of the control grip configured to be acted against on one side by a forefinger of an operator's hand.

15. The multifunction palm-on-top control grip of claim 13, wherein the control switches are arranged to be manipulated by the thumb of the hand without repositioning the hand on the hand rest.

16. The multifunction palm-on-top control grip of claim 15, wherein a front peripheral region of the control grip includes a control switch arranged to be manipulated with the forefinger simultaneously with thumb manipulation of the control switches on the control face without repositioning the hand on the hand rest.

17. The multifunction palm-on-top control grip of claim 16, wherein the control switches on the control face are arranged at an oblique angle relative to a lower bound of the control grip.

18. In a work vehicle having a cabin with an operator station including a seat mounted to a floor, a multifunction control comprising:
a control lever mounted within the operator station; and
a palm-on-top control grip mounted to the control lever and having a housing defining:
a hand rest forming a contoured convex surface extending from a first side of the control grip;
a control face forming a planar surface that mounts one or more control switches arranged to be manipulated by a thumb of the operator and which are operatively coupled to components of the work vehicle; and
a pommel forming a raised projection between at least a portion of the hand rest and the control face that is configured to be acted against by a hand of an operator;
wherein the control grip is mounted to the control lever such that the pommel projects in an upward direction away from the floor and the control face extends in an plane approximately normal to the floor.

19. The multifunction control of claim 18, wherein a front peripheral region of the control grip includes a recessed control switch arranged to be manipulated with a finger of the operator without repositioning the hand on the hand rest.

20. The multifunction palm-on-top control grip of claim 19, wherein the one or more control switches mounted to the control face include a clutch control switch, a kickdown switch, and a rocker switch, and wherein the control switch mounted to the front peripheral region is a manual four wheel drive switch;
wherein the manual four wheel drive switch is arranged such that simultaneous activation of the manual four wheel drive switch and any of the clutch control switch, the kickdown switch, and the rocker switch is achievable without repositioning the hand on the hand rest.
